(19) United States
(12) Patent Application Publication
(10) Pub. No.: US 2012/0271816 A1
(43) Pub. Date: Oct. 25, 2012

(54) SYSTEM AND METHOD FOR QUANTIFYING VEHICLE MAINTENANCE COSTS AND FREQUENCY BASED ON STATISTICAL REPAIR DATA

(75) Inventor: Daniel Christopher Hansberger, Edmond, OK (US)

(73) Assignee: SILENT SEMI LLC, Edmond, OK (US)

(21) Appl. No.: 13/275,215

(22) Filed: Oct. 17, 2011

Related U.S. Application Data
(60) Provisional application No. 61/394,936, filed on Oct. 20, 2010.

(51) Int. Cl. G06F 17/30

(52) U.S. Cl. 707/722; 707/E17.014

(57) ABSTRACT

The present invention generally relates to quantifying vehicle maintenance data. Specifically, this invention relates to a system and method for quantifying vehicle maintenance cost and frequency based on statistical repair data. In part, the systems and methods herein described are configured to provide actionable information based on the quantified vehicle maintenance data.

### CROSS REFERENCE TO RELATED APPLICATIONS

This application claims the benefit of U.S. Provisional Patent Application No. 61/394,936 Filed Oct. 20, 2010, the entire disclosure of which is incorporated herein by reference.

### FIELD OF THE INVENTION

The present invention generally relates to quantifying vehicle maintenance data. Specifically, this invention relates to a system and method for quantifying vehicle maintenance cost and frequency based on statistical repair data. In part, the systems and methods herein described are configured to provide actionable information based on the quantified vehicle maintenance data.

### BACKGROUND

The purchase, maintenance and repair of an automobile is one of the greatest expenses to most individuals. With millions of vehicles on the road, there is a vast amount of data being generated and recorded in various manners with respect to the use, operation, maintenance and repair of hundreds, if not thousands, of makes and models of vehicles. This data forms an overarching body of information that contains within it numerous data points that could prove extremely valuable if gathered, organized and utilized properly.

One problem currently is that there are no entities currently accumulating the this data and organizing it in such a manner as to be useful to the millions of car owners and buyers in the market. While some companies are gathering data about specific cars and what has occurred to a particular vehicle, no one is taking all the available data points available and utilizing these data points to generate data view models that predict specific relevant data points between defined intervals or other specifications.

Therefore, there is a need in the art for a system and method configured to assemble vehicle information data points based on one or more criteria and generate quantitative predictions based on the assembled data points. These and other features and advantages of the present invention will be explained and will become obvious to one skilled in the art through the summary of the invention that follows.

### SUMMARY OF THE INVENTION

Accordingly, it is an object of the present invention to provide a system and method for generating and providing quantitative predictions based on assembled data points. Specifically, the systems and methods provided herein are directed to generating and providing quantitative predictions related to maintenance, repair and an economic lifespan of one or more vehicles.

According to an embodiment of the present invention, the systems and methods herein described are provided via one or more computing devices over one or more networks. Quantitative analysis may be generated in real-time or running data analysis may be performed as new data becomes available. One or more users may be provided functionality to receive the analyses upon request, whether related to a specific data point or multiple data points in conjunction with one another (e.g., an individual vehicle or numerous vehicles in comparison with one another).

According to an embodiment of the present invention, the data being compared may be utilized to determine an average, mean or other representation of when a particular component of a vehicle may fail (e.g., between 100,000 miles and 120,000 miles).

According to an embodiment of the present invention, the data being compared may be utilized to determine an average, mean or other representation of when a vehicle may suffer a catastrophic failure (e.g., complete engine failure). An economic life/death of a vehicle may be measured in terms of time (e.g., 6 months) or miles (e.g., 10,000 miles).

According to an embodiment of the present invention, the system and methods herein described may be utilized to determine an average, mean or other representation of when a vehicle may come to an economic death point (i.e., when the cost to repair the vehicle is more than the vehicle value or the cost to replace the vehicle).

According to an embodiment of the present invention, the system and methods herein described are configured to present to the consumer, via a software module stored on a tangible computer-readable medium, an interface for identifying a vehicle based on one or more vehicle characteristics. The system and methods are further configured to receive input from the user, wherein the input identifies a vehicle of interest.

According to an embodiment of the present invention, the system and methods herein described are configured to retrieve data related to a vehicle of interest from a data store and generate a quantitative data set related to the vehicle of interest.

According to an embodiment of the present invention, the system and methods herein described are configured to provide a graphical representation to a user, wherein the graphical representation is related to a quantitative data set related to a vehicle of interest.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of the network system for carrying out this invention, in accordance with an embodiment of the present invention;

FIG. 2 is an exemplary embodiment of a vehicle comparison breakdown, in accordance with an embodiment of the present invention;

FIG. 3 is an exemplary embodiment of a method for receiving vehicle information data, in accordance with an embodiment of the present invention;

FIG. 4 is an exemplary embodiment of a graphical representation of quantitative data with respect to a particular vehicle, in accordance with an embodiment of the present invention;

FIG. 5 is an exemplary embodiment of a graphical representation of quantitative data with respect to a particular vehicle, in accordance with an embodiment of the present invention;

FIG. 6 is an exemplary embodiment of a method for providing quantitative representations of data related to a user, in accordance with an embodiment of the present invention; and

FIG. 7 is an exemplary embodiment of a vehicle future report, in accordance with an embodiment of the present invention.

### DETAILED SPECIFICATION

According to embodiments of the present invention, a system and method is provided to quantitatively predict vehicle maintenance costs and vehicle failure. In particular, the system and method provided herein uses large amounts of collected statistical data to quantitatively predict failures in vehicles, either minor or catastrophic, based on one or more criteria contained in the collected statistical data.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

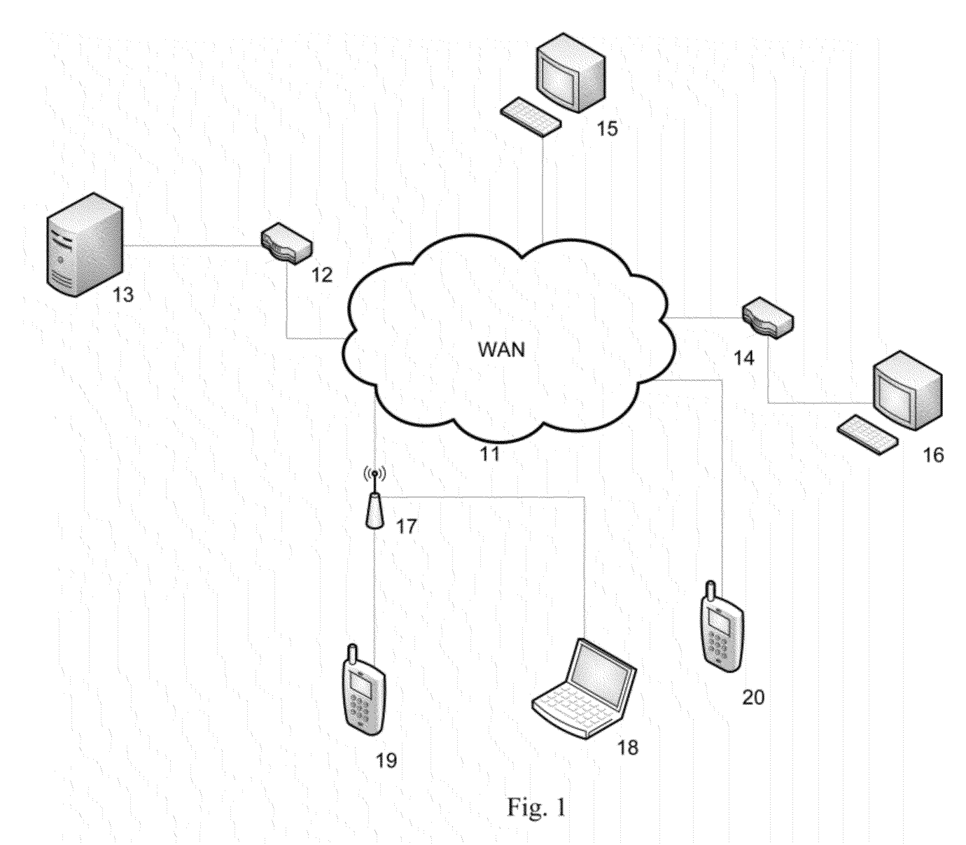

Referring to FIG. 1, a schematic overview of a system in accordance with an embodiment of the present invention is shown. The system is comprised of one or more application servers 13 for electronically storing information used by the system. Applications in the server 13 may retrieve and manipulate information in storage devices and exchange information through a WAN 11 (e.g., the Internet).

According to an exemplary embodiment, as shown in FIG. 1, exchange of information through the WAN 11 or other network may occur through one or more high speed connections directed through one or more routers 12. Router(s) 12 are completely optional and other embodiments in accordance with the present invention may or may not utilize one or more routers 12. One of ordinary skill in the art would appreciate that there are numerous ways server 13 may connect to WAN 11 for the exchange of information, and embodiments of the present invention are contemplated for use with any method for connecting to networks for the purpose of exchanging information.

Members may connect to server 13 via WAN 11 or other network in numerous ways. For instance, a Member may connect to the system i) through a computing device 15 directly connected to the WAN 11, ii) through a computing device 16 connected to the WAN 11 through a routing device 14, iii) through a computing device 18 or 19 connected to a wireless access point 17 or iv) through a computing device 20 via a wireless connection (e.g., CDMA, GMS, 3G, 4G) to the WAN 11. One of ordinary skill in the art would appreciate that there are numerous ways that a member may connect to Server 13 via WAN 11 or other network, and embodiments of the present invention are contemplated for use with any method for connecting to Server 13 via WAN 11 or other network.

According to an embodiment of the present invention, an individual or organization may signup to become a member of the system herein provided. In an exemplary embodiment, an individual or organization would go through a registration process, whereby they would provide identifying information to be stored in application server 13. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes.

By collecting large amounts of data related to the repair and maintenance of vehicles, data points and models can be produced to quantitatively predict when a vehicle will have a component failure, what component(s) will fail and what the estimated repair cost could be. Repair and maintenance data collected may include, but is not limited to, an odometer reading at the time of a failure, what component failed, a repair cost, a location of the repair and the make, model and year of a vehicle. One of ordinary skill in the art would appreciate that numerous forms of repair and maintenance data could be collected in accordance with embodiments of the present invention, and embodiments of the present invention are contemplated for use with any form of repair and maintenance data.

From the maintenance and repair data, one or more data points may be derived. Data points derived from the repair and maintenance data collected may include, but are not limited to, frequency at which maintenance service occurs, cost of maintenance services, frequency at which catastrophic (e.g., engine/transmission failure) maintenance events occur, cost of repairing catastrophic failures, total maintenance costs over specified odometer intervals and geographic location. For example, by looking at all stored repair and maintenance data related to a particular vehicle (make/model/year), the system, in accordance with an embodiment of the present invention, could quantitatively determine the statistical chance of an unscheduled maintenance event between two predetermined odometer readings (e.g., 140,000-150,000 miles). One of ordinary skill in the art would appreciate that numerous data points could be derived and used with embodiments of the present invention and embodiments of the present invention are contemplated for use with any data point.

According to an embodiment of the present invention, the data related to the repair and maintenance of vehicles may be collected from numerous entities through a variety of means. For example, mechanics and dealerships with service departments may provide the data directly to the system via electronic or other means. In another embodiment, the data may be received from vehicle diagnostic and record keeping software, such as Snap-On Diagnostic's Shopkey software.

According to an embodiment of the present invention, the above described data points could be used in numerous ways. For example, the data points mentioned above could be used to quantitatively determine an economic death of a vehicle. The economic death of a vehicle is the point at which the real or predicted cumulative cost to maintain the vehicle is more than the vehicle's value, as specified by an industry accepted source. This could be based on a vehicle's physical age, the odometer reading or any other data point as previously disclosed.

According to an embodiment of the present invention, the above described data points could be used to quantitatively determine a remaining economic life of a vehicle. The economic life of a vehicle is the amount of some data point (e.g., mileage, years old) from purchase or from being brand new until economic death. For example, if statistical data suggests that a vehicle with 140,000 miles on it (worth $3,000) will experience a catastrophic engine failure (e.g., costing $3,000) at 150,000 miles, the remaining economic life of the vehicle would be 10,000 miles.

According to an embodiment of the present invention, the economic life/death of a vehicle may be used to calculate a revised vehicle value. The revised vehicle value may be based in part on, for instance, an estimated cumulative maintenance cost of a vehicle versus the value cited by standard valuation methods used by organizations like Kelley's Blue Book and Edmunds. For example, if statistical data shows that an individual will likely spend $1,500 between the odometer readings of 140,000 and 150,000 miles and the difference in the value of a car with 140,000 miles and the value of the same car with 150,000 miles, according to Kelley's Blue Book, is only $100, then the revised vehicle value would include a reduction in the vehicle's value to reflect the likelihood of a significant expenditure in that odometer interval.

According to an embodiment of the present invention, the above described data points could be used to quantitatively determine the average price for the diagnosis and/or replacement of a component of a vehicle. For example, with data points related to the vehicle, the repair of the particular vehicle make, model and year along with statistical averages for diagnosis and repair in the geographic location, a prediction or estimation for the final diagnosis and repair cost could be provided to a consumer, mechanic or other user of the present invention.

Embodiments of the present invention have numerous applications. Applications include, but are not limited to, i) assisting prospective consumers of used vehicles educate themselves in order to make smart purchases, sales and/or leases of vehicles, ii) assisting lenders in making decisions on whether to make a loan based, for instance, on the probability and timing of a catastrophic or other failure of a particular vehicle being purchased, iii) assisting vehicle dealership in providing information related to particular makes or models of vehicles they sell, and iv) assisting vehicle valuation organizations in correcting estimated vehicle valuations based on statistical averages related to the aforementioned data points. One of ordinary skill in the art would appreciate that these are but a few of the beneficial applications in accordance with embodiments of the present invention, and embodiments of the present invention are contemplated for use with all beneficial applications of quantitatively predicting vehicle maintenance costs and vehicle failures based on statistical analysis of data points.

According to another embodiment of the present invention, statistical data may be used quantitatively to provide a probability of failure and degree of failure based upon one or more of the plurality of data points accessible by the system. In this manner, information can be provided based upon the plurality of data points. Examples of information that could be provided include, but are not limited to, a list showing which vehicle of model year 1999 is the cheapest to maintain, a list showing which make of vehicles are the cheapest to maintain and which model year of a particular model is the cheapest to maintain. One of ordinary skill in the art would appreciate that there are numerous ways to format and utilize this information and embodiments of the present invention are contemplated for use with any way of formatting and utilizing the information.

According to another embodiment of the present invention, use of quantitative presentations of information based on the aforementioned data points allows for users of the system to make decisions based on potential unscheduled maintenance costs or events. For example, if the statistical data showed that a particular vehicle make/model/year combination suffered a catastrophic transmission failure between the odometer reading of 140,000 and 150,000 miles 80% of the time, the owner could begin preventative or reactive maintenance before the vehicle suffered a catastrophic failure during regular vehicle operation. Alternatively, an owner of a vehicle in the previous example could make the decision to sell or trade the vehicle for a new or used vehicle and avoid the probability of the vehicle suffering a catastrophic failure altogether.

According to another embodiment of the present invention, the information derived from the data points could be used to quantitatively identify vehicles, makes, or models with concerning records. For example, if the data points showed that a particular make and model of vehicle suffered unusually expensive (e.g., >$1,500) unscheduled maintenance events at low odometer readings (e.g., <60,000 miles), individuals or groups of individuals could use this data to avoid that make and model of vehicle or research the possibility that the particular make and model of vehicle suffers from a defect that could be pursued with the manufacturer or other entity.

According to another embodiment in accordance with the present application, the information derived from the data points could be used to quantitatively identify vehicles, makes, or models with frequently diagnosed minor failures. For example, the data points could be used to show what makes/model/years of vehicles have statistically high probability for minor failures including, but not limited to, cracked windshields, cabin comfort failures (e.g. power seats, power mirrors, stereo, lights, GPS navigation systems), headlight failures, brake light failures and security system failures (e.g., airbag issues, locking failures, remote keyless entry failures).

According to another embodiment in accordance with the present application, the information derived from the data points could be used to quantitatively identify the total maintenance cost over a given odometer interval of a particular vehicle. This could be extended to include total maintenance cost based on additional data points, including, but not limited to, geographic location, data points associated with vehicle owners (e.g., age, gender, ethnicity) and vehicle usage characteristics (e.g., mostly highway, mostly rural, mostly city, stored in a garage, parked on city streets). For example, during the purchase of a used vehicle, the prospective buyer could reliably incorporate the anticipated total maintenance cost into the decision making process of choosing the most “economical” vehicle.

According to another embodiment in accordance with the present application, the information derived from the data points could be used to help a consumer identify vehicles, similar to ones identified by a consumer as desirable, that may have better statistical economic life analysis. For example, a prospective buyer might utilize this information to differentiate between similar foreign made four-door sedans or differentiate between similar American made two-door, extended cab, pickup trucks.

According to another embodiment in accordance with the present application, the information derived from the data points could be used to quantitatively determine the impact of failing to perform any given scheduled maintenance. For instance, information regarding the failure to perform regularly scheduled oil changes could be used to quantitatively determine if such failures result in increased maintenance costs over the life of a car or over a given odometer range. Continuing from the previous example, the same information could be used to determine if such failures are likely to increase the risk of a catastrophic failure over the life of a car or over a given odometer range. For example, one could determine whether changing the oil every 3,000 miles actually extends the life of a vehicle. Additionally, one could determine the ideal frequency for changing oil before total maintenance costs increase, chance for catastrophic failure increases or the economic life of vehicle is shortened.

According to another embodiment in accordance with the present application, the information derived from the data points could be used to provide users with meaningful conclusions related to one or more of the collected data points. For instance, users may be provided with information related to: i) the average maintenance cost per mile driven for a given year/make/model/engine type over a given odometer interval in a given geographical area; ii) the average number of trips to vehicle maintenance facility for a given year/make/model/engine type over a given odometer interval in a given geographical area; the average cost per trip to the vehicle maintenance facility for a given year/make/model/engine type over a given odometer interval in a given geographical area; the probability of a significant (engine/transmission) maintenance failure over a specified odometer interval for a given year/make/model/engine type in a given geographical area; the average cost of specific component for a given year/make/model/geographical area; or the average total maintenance cost for a given year/make/model/engine type over a given odometer interval in a given geographical area.

According to another embodiment in accordance with the present application, the information derived from the data points could be used to provide users with fair maintenance/repair costs related to specific failures and repairs, based upon, for instance, geographic location and type of service provider (e.g., independent mechanic, dealership service center).

According to another embodiment in accordance with the present application, the information derived from the data points could be used to provide users with statistical information as to whether preventative (e.g., scheduled) maintenance lowers the overall long term maintenance cost of a vehicle.

According to another embodiment in accordance with the present application, the information derived from the data points could be used to provide users with statistical information related to how much a particular visit to a mechanic or repair shop for scheduled or unscheduled maintenance should be based upon any number of data points, including, but not limited to, current odometer reading.

### Exemplary Embodiments

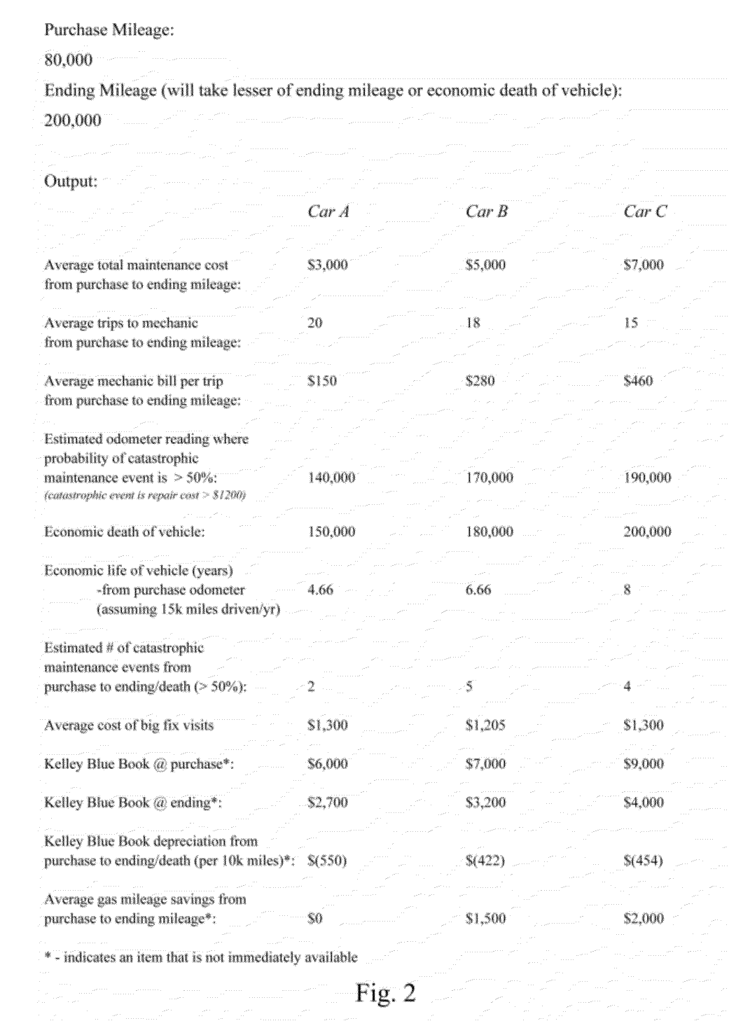

Turning now to FIG. 2, an exemplary embodiment of a vehicle future report, in accordance with an embodiment of the present invention, is shown. In this figure, a comparison between 6 different vehicles is shown. The vehicle future report shows information regarding industry accepted values of represented vehicles based on mileage that is based on data stored in the system. In this manner, a user may be provided data points in relation to an important characteristic of each vehicle. One of ordinary skill in the art will appreciate that the information shown is merely for example purposes, and that numerous other data points may be shown or referenced, depending on the particular vehicle future report or other report requested by a user.

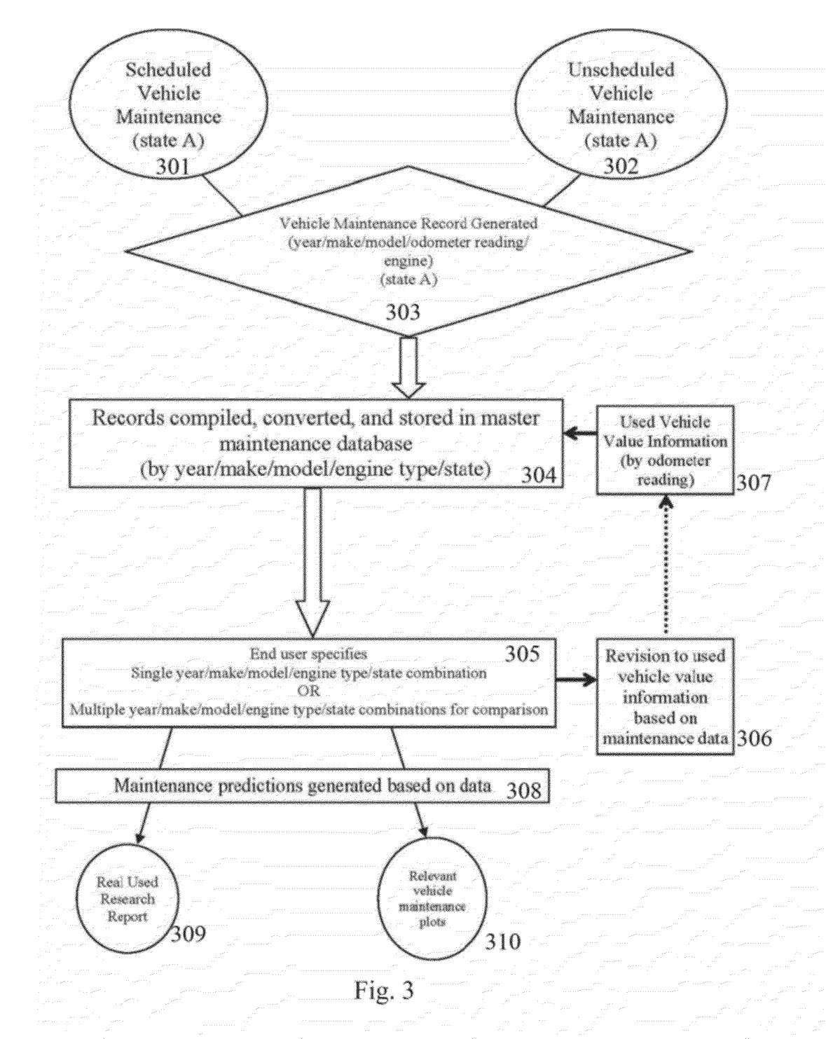

Turning now to FIG. 3, an exemplary embodiment of a method for receiving vehicle information data, in accordance with an embodiment of the present invention, is shown. In this figure, the method may start at either step 301 or 302. Step 301 represents a scheduled vehicle maintenance event (e.g., oil change) and step 302 represents an unscheduled vehicle maintenance event (e.g., oil leak).

At step 303, the system is engaged to record a particular maintenance event, whether scheduled or unscheduled. In a preferred embodiment, a minimum amount of information is required in order to process the recordation of a maintenance event. This information may include, but is not limited to, make of a vehicle, model of a vehicle, year of a vehicle, odometer reading of a vehicle and type of maintenance event.

At step 304, the system records the particular maintenance event. The recordation process may include converting the maintenance event into an appropriate format for recordation, compiling the data with other stored data points in order to keep the data in a constant ready state and storing the record in a master maintenance database with one or more record pointers (e.g., make of the vehicle, model of the vehicle, engine type, state).

At step 305, a user engages the system to retrieve information regarding a particular vehicle or multiple vehicles for comparison. Optionally at this step, if the system did not recalculate effects of new maintenance events on the data currently stored by the system, the system may proceed to step 308. At step 307, the system has recalculated and regenerated the pertinent data points and the system proceeds back through the loop.

At step 308, the system generates the requested predictions and presentations for the user based on the data stored in the system. At this point, the system may generate one or more reports or graphical representations based on the requests received from a user. The user then will be provided the requested reports (e.g., Vehicle Future Report at step 309 or one or more relevant vehicle maintenance plots at step 310).

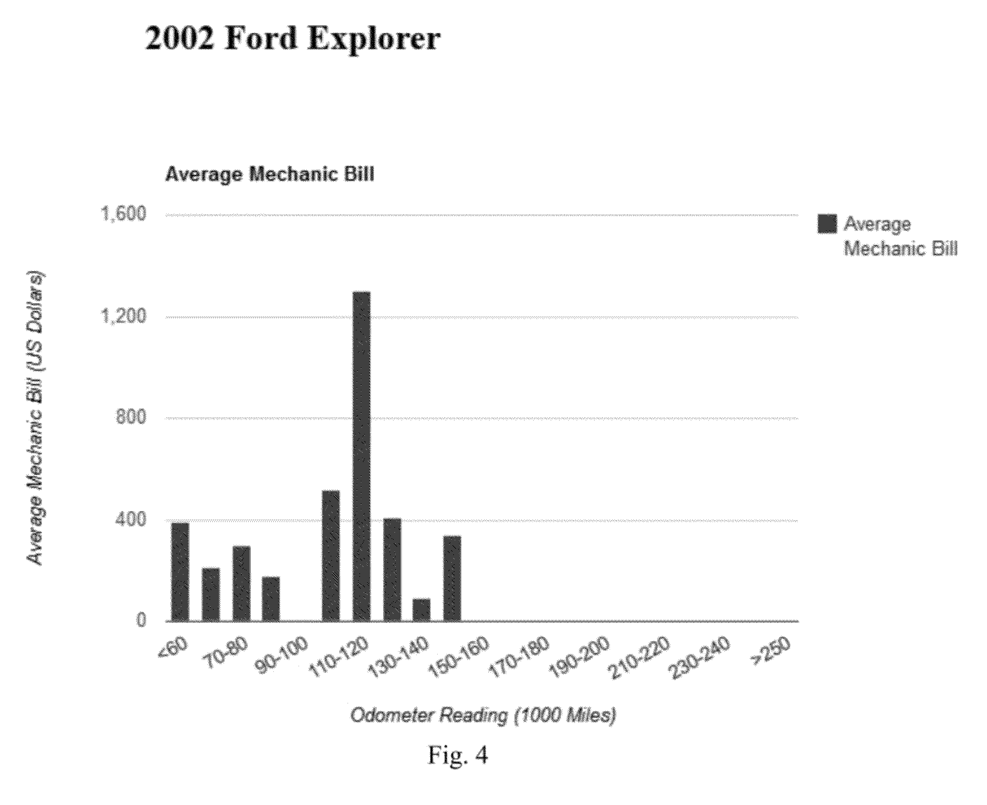

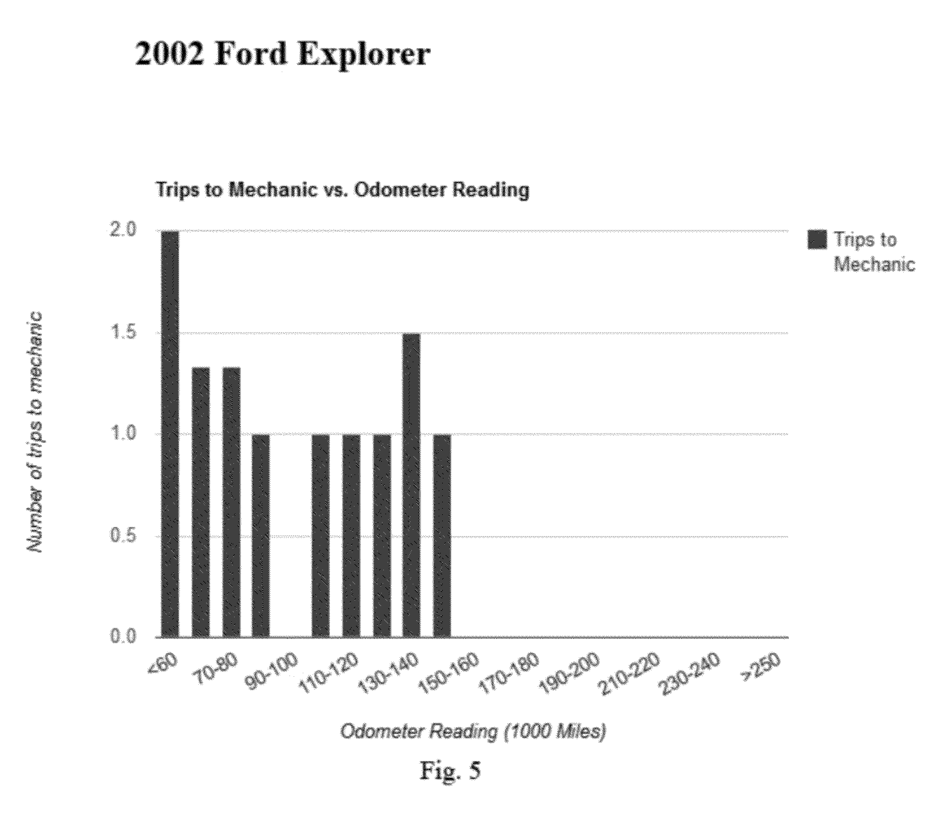

Turning now to FIGS. 4 and 5, exemplary embodiments of graphical representations of quantitative data with respect to a particular vehicle, in accordance with an embodiment of the present invention, are shown. As discussed previously, graphical representations may be presented to a user in order to help them assess particular data points regarding a vehicle, in particular a view over a period of time. FIG. 4 represents an average mechanic bill based on dollars spent on a repair between particular odometer readings for a 2002 Ford Explorer. FIG. 5 represents the number of trips to a mechanic between a specified odometer reading for a 2002 Ford Explorer. These representations are for example purposes only. One of ordinary skill in the art would appreciate that there are numerous ways to represent the aforementioned data types and numerous data points that may be represented in this fashion, in accordance to embodiments of the present invention.

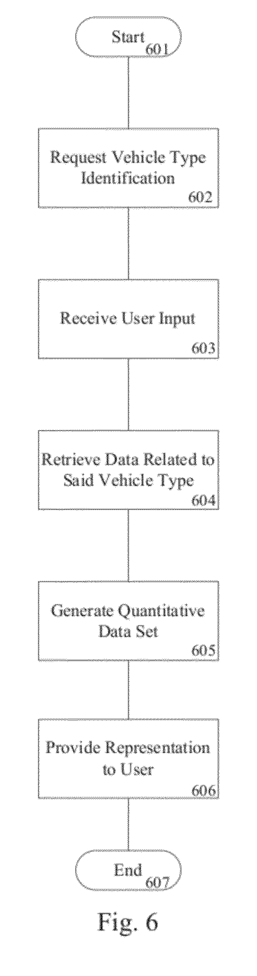

Turning now to FIG. 6, an exemplary embodiment of a method for providing quantitative representations of data related to a user, in accordance with an embodiment of the present invention, is shown. The method starts at step 601, where a user has successfully logged in or registered with the system. At this point, the system proceeds to step 602, where the system requests the user to identify one or more vehicle types for comparison or reporting on.

At step 603, the system receives input from the user relating to the one or more vehicles the user would like to receive information about. The system processes the input into a format that is usable by the one or more software and hardware components incorporated into and utilized by the system.

At step 604, the system retrieves data related to each of the vehicle types identified by the user. This information may be retrieved from one or more databases, one or more storage mediums, one or more data stores or any other medium appropriate for storing data points as described in this application.

At step 605, the system utilizes the retrieved information to generate a quantitative data set representing points of interest related to the data. In a preferred embodiment, the quantitative data will represent information regarding the one or more vehicle types identified by the user over some interval (e.g., time period, odometer reading).

At step 606, the system creates and provides to the user one or more representations to the user based on information contained in the quantitative data set. Preferably, this information is represented in a manner that is easily consumable and understandable by the user. At this point (step 607) the process ends. One of ordinary skill in the art would appreciate that the steps enumerated above are for exemplary purposes only and that additional of fewer steps may be utilized. One of ordinary skill in the art would appreciate that the steps enumerated above do not necessarily execute in the order outlined above, with some of the steps potentially occurring at the same time, in parallel or in series with one another.

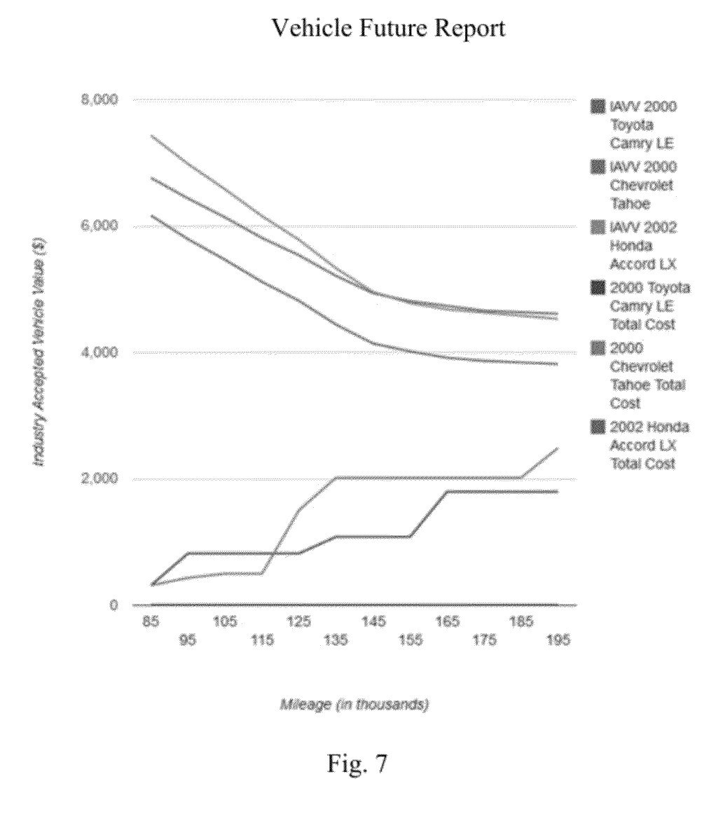

Turning now to FIG. 7, an exemplary embodiment of a vehicle future report, in accordance with an embodiment of the present invention, is shown. In this figure, a comparison between 6 different vehicles is shown. The vehicle future report shows information regarding industry accepted values of represented vehicles based on mileage that is based on data stored in the system. In this manner, a user may be provided data points in relation to an important characteristic of each vehicle. One of ordinary skill in the art will appreciate that the information shown is merely for example purposes, and that numerous other data points may be shown or referenced, depending on the particular vehicle future report or other report requested by a user.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A computer-readable medium that stores computer-executable instructions that are executable by a computer processor, the instructions when executed embodying a method that comprises:
using a computer processor to store, in a tangible computer-readable medium, a plurality of methods for providing a consumer with access to data related to one or more vehicles;
presenting to the consumer, via a software module stored on said tangible computer-readable medium, an interface for identifying a vehicle based on one or more vehicle characteristics;
receiving input from said user, wherein said input identifies a vehicle of interest,
retrieving data related to said vehicle of interest from a data store;
generating a quantitative data set related to said vehicle of interest; and
providing a graphical representation to said user,
wherein said graphical representation is related to said quantitative data set related to said vehicle of interest.

2. The computer-readable medium of claim 1, wherein said vehicle characteristics comprises a vehicle make, a vehicle model and a vehicle year.

3. The computer-readable medium of claim 1, wherein said vehicle characteristics comprises a vehicle odometer reading.

4. The computer-readable medium of claim 1, wherein said vehicle characteristics comprises a vehicle engine type.

5. The computer-readable medium of claim 1, wherein said quantitative data set comprises an economic life of a vehicle.

6. The computer-readable medium of claim 1, wherein said quantitative data set comprises an economic death of a vehicle.

7. The computer-readable medium of claim 1, wherein said quantitative data set comprises an estimated number of catastrophic maintenance events that will occur from purchase to economic death.

8. The computer-readable medium of claim 1, wherein said quantitative data set comprises an estimated cost of repair for a maintenance request between a first odometer reading and a second odometer reading.

9. A computer implemented method for providing a consumer with access to service providers matching one or more characteristics, said method comprising the steps of:
using a computer processor to store, in a tangible computer-readable medium, a plurality of methods for providing a consumer with access to data related to one or more vehicles;
presenting to the consumer, via a software module stored on said tangible computer-readable medium, an interface for identifying a vehicle based on one or more vehicle characteristics;
receiving input from said user, wherein said input identifies a vehicle of interest,
retrieving data related to said vehicle of interest from a data store;
generating a quantitative data set related to said vehicle of interest; and
providing a graphical representation to said user,
wherein said graphical representation is related to said quantitative data set related to said vehicle of interest.

10. The method of claim 9, wherein said vehicle characteristics comprises a vehicle make, a vehicle model and a vehicle year.

11. The method of claim 9, wherein said vehicle characteristics comprises a vehicle odometer reading.

12. The method of claim 9, wherein said vehicle characteristics comprises a vehicle engine type.

13. The method of claim 9, wherein said quantitative data set comprises an economic life of a vehicle.

14. The method of claim 9, wherein said quantitative data set comprises an economic death of a vehicle.

15. The method of claim 9, wherein said quantitative data set comprises an estimated number of catastrophic maintenance events that will occur from purchase to economic death.

16. The method of claim 9, wherein said quantitative data set comprises an estimated cost of repair for a maintenance request between a first odometer reading and a second odometer reading.
